(19) United States
(12) Patent Application Publication
(10) Pub. No.: US 2013/0269401 A1
(43) Pub. Date: Oct. 17, 2013

(54) DEADBOLT LATCH LOCK

(71) Applicant: Marcus Anthony Allen, SR., Westland, MI (US)

(72) Inventor: Marcus Anthony Allen, SR., Westland, MI (US)

(21) Appl. No.: 13/864,169

(22) Filed: Apr. 16, 2013

Related U.S. Application Data
(60) Provisional application No. 61/624,781, filed on Apr. 16, 2012.

(51) Int. Cl. E05B 59/00

(52) U.S. Cl. CPC E05B 59/00
USPC 70/107

(57) ABSTRACT

A deadbolt latch lock can mount to a door and secure a deadbolt latch in a locked position. The deadbolt latch lock can prevent a would-be intruder or thief from manipulating the deadbolt lock and turning the lock to unlock it. By retaining the latch in a locked position, there is no way to unlock the lock, even with the key, from outside of the home or business.

### CROSS-REFERENCE TO RELATED APPLICATION

This application claims the benefit of priority of U.S. provisional application No. 61/624,781, filed Apr. 16, 2012, the contents of which are herein incorporated by reference.

### BACKGROUND OF THE INVENTION

The present invention relates to deadbolt lock accessories and, more particularly, to a deadbolt latch lock that is a supplementary and complementary locking device that aids the standard deadbolt locking system.

The deadbolt lock is a free standing mechanism that is able to open with the turn of a key. There is nothing on the device, however, that can prevent someone from manipulating it with a makeshift device to gain entry. For example, a thief can manipulate the pins in a lockset to pick the lock and permit turning of the latch mechanism.

While alarm systems are often employed to protect one's home or business, these alarms do not prevent thieves or invaders from gaining entry in the first place.

As can be seen, there is a need for a device that prevents unauthorized manipulation of a lock to gain access.

### SUMMARY OF THE INVENTION

In one aspect of the present invention, a deadbolt latch lock comprises a latch plate operable to attach to a door; a latch extending from the latch plate, the latch movable between a secured position and a storage position, the secured position resulting in the latch extending on each side of a deadbolt knob when the deadbolt knob is in a locked position, preventing the deadbolt knob from turning to an unlocked position, and the storage position resulting in the latch not interfering with the turning of the deadbolt knob.

In another aspect of the present invention, a method for securing a deadbolt knob of a deadbolt lock in a locked position comprises pivoting a latch from a storage position, where the latch does not interfere with movement of the deadbolt knob, to a secured position, where the latch is disposed along each side of the deadbolt knob, preventing rotation of the deadbolt knob from a locked position to an unlocked position.

These and other features, aspects and advantages of the present invention will become better understood with reference to the following drawings, description and claims.

### BRIEF DESCRIPTION OF THE DRAWINGS

FIG. 1 is a perspective view of a deadbolt lock having a deadbolt latch lock installed thereon, according to an exemplary embodiment of the present invention;

FIG. 2 is a front, exploded perspective view of the deadbolt latch lock of FIG. 1;

FIG. 3 is a back, exploded perspective view of the deadbolt latch lock of FIG. 1;

FIG. 4 is a front view of the deadbolt latch lock of FIG. 1;

FIG. 5 is a rear view of the deadbolt latch lock of FIG. 1;

FIG. 6 is a cross-sectional view taken along line 6-6 of FIG. 4; and

FIG. 7 is a cross-sectional view taken along line 7-7 of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a deadbolt latch lock that can mount to a door and secure a deadbolt latch in a locked position. The deadbolt latch lock can prevent a would-be intruder or thief from manipulating the deadbolt lock and turning the lock to unlock it. By retaining the latch in a locked position, there is no way to unlock the lock, even with the key, from outside of the home or business.

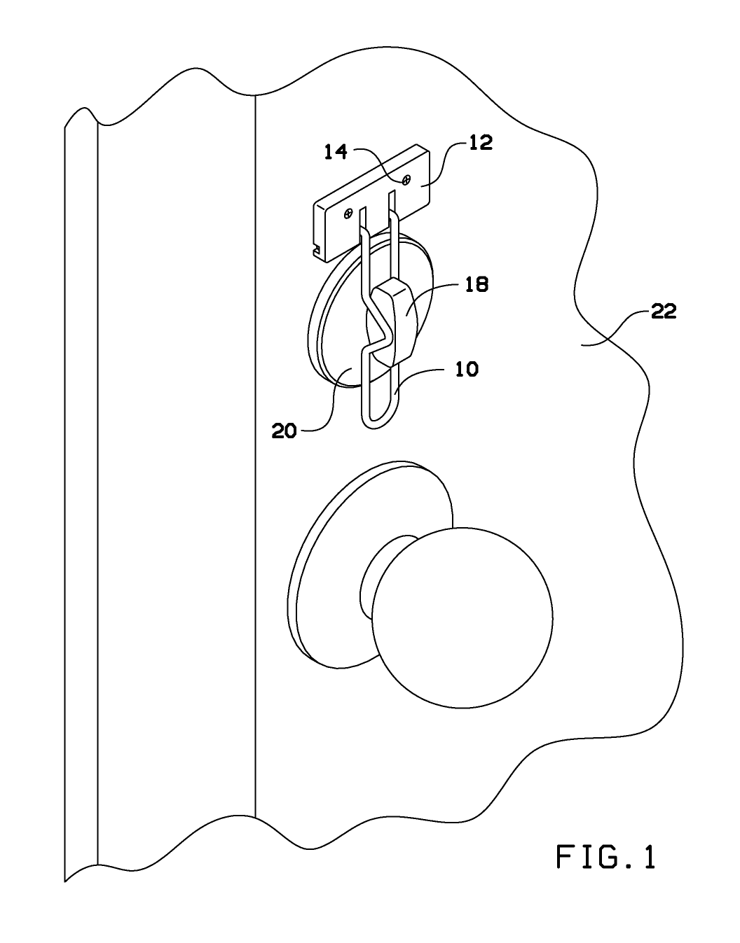

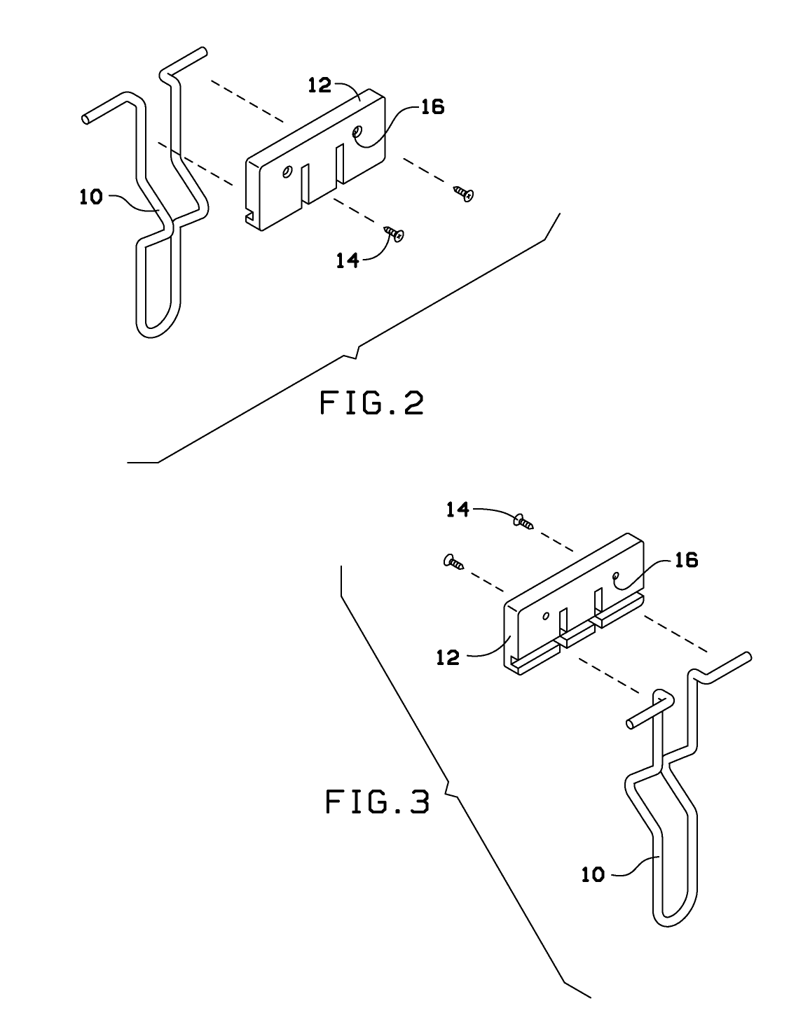

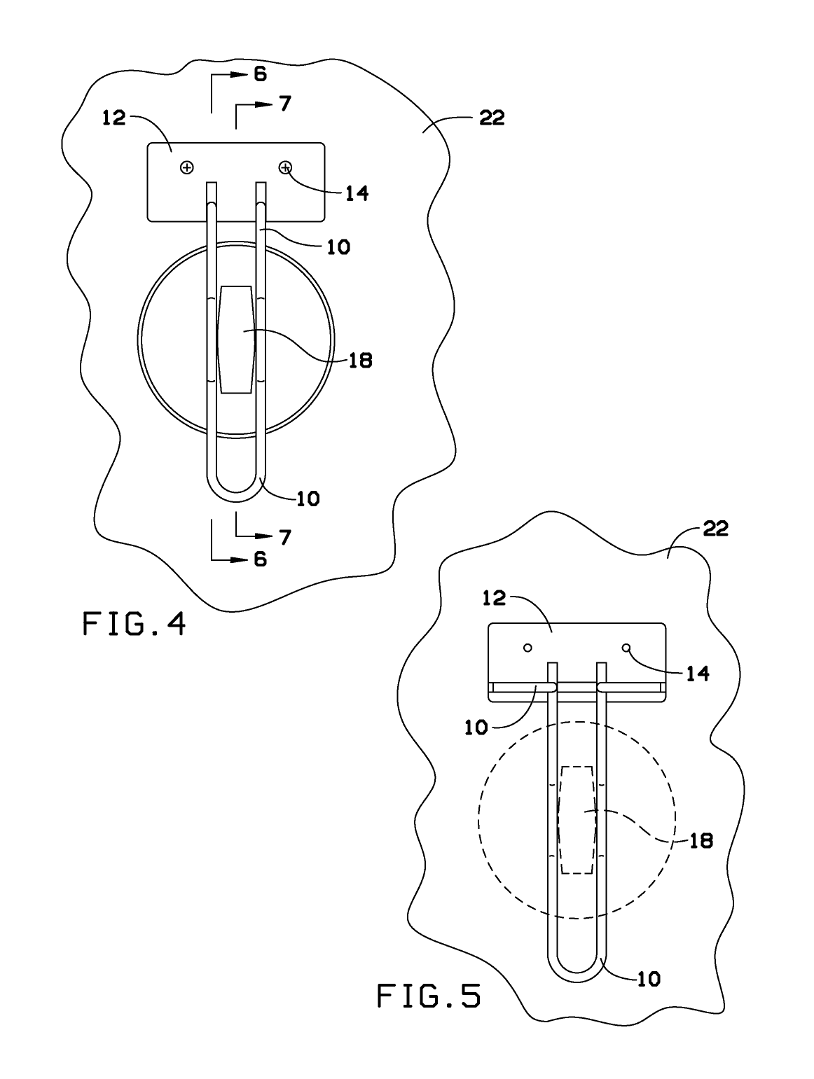

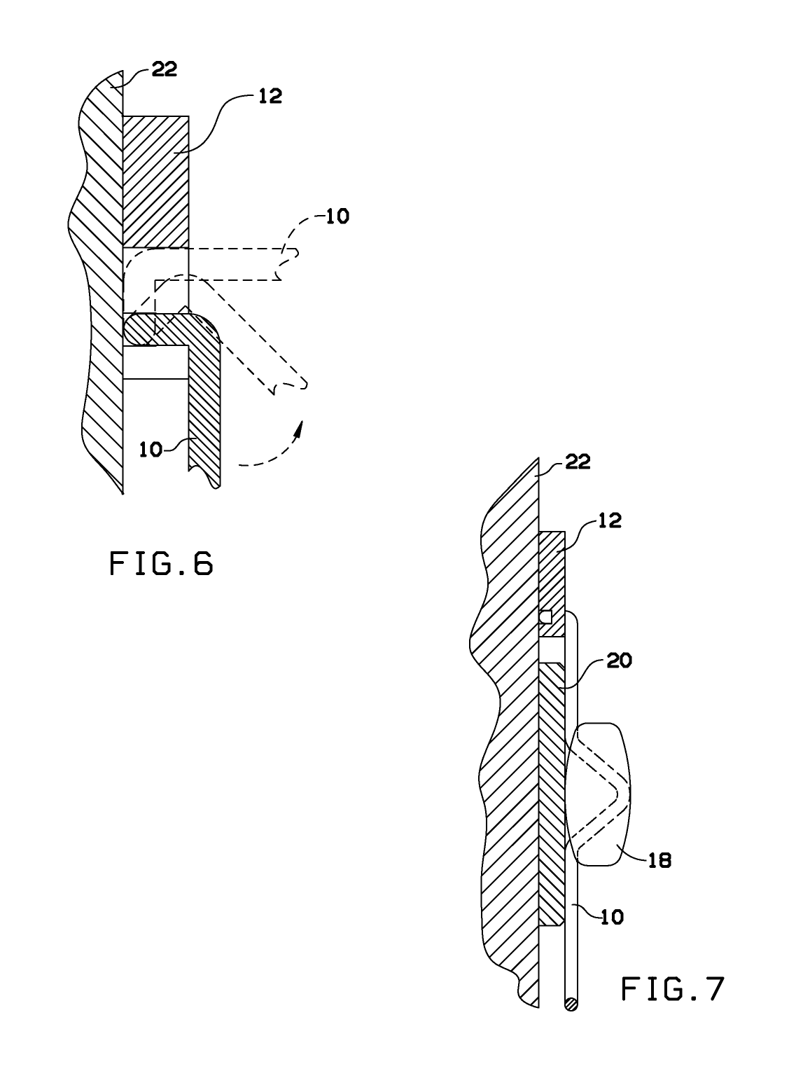

Referring now to FIGS. 1 through 7, a deadbolt latch lock includes latch plate 12 that can attach to an inside surface of a door 22. A latch 10 can be hingedly attached to the latch plate 12 so that the latch 10 can move between a secured position, where the latch 10 is disposed on each side of a deadbolt knob 18, preventing the deadbolt knob 18 from turning, and a storage position, where the latch 10 does not inhibit the turning of the deadbolt knob 18.

The latch plate 12 can attach to the door 22 by various mechanisms. For example, as shown in the Figures, the latch plate 12 can attach to the door 22 with screws 14 that can be inserted into screw holes 16 in the latch plate 12. In other embodiments, the latch plate 12 can be secured to the door 22 with other mechanisms, such as with an adhesive.

The latch 10 can be hingedly connected to the latch plate 12 by various methods, provided that the latch 10 can move between the secured position and the storage position. As shown in the Figures, the latch 10 can include members that extend orthogonal to the deadbolt knob 18 (in the locked position), where the members rest in channels cut in the backside of the latch plate 12, allowing the latch 10 to swing on these members and move between the secured position and the storage position. Of course, other configurations are contemplated within the scope of the present invention.

In some embodiments, there may be a mechanism to resiliently retain the latch 10 in both the secured position and the storage position. For example, a catch could be disposed on a side of the deadbolt knob 18 opposite that where the latch plate 12 is disposed. This catch could catch and hold the latch 10 in the secured position. A similar type of catch could be employed above the latch plate 12 to hold the latch 10 in the storage position. In other embodiments, a spring load could be used to hold the latch 10 in the secured and/or storage positions. In some embodiments, the latch 10 can be made with side members that straddle the deadbolt knob 18, as shown in the Figures. These side members can be spaced apart a distance smaller than the deadbolt knob 18 so that the side members resiliently open to press against the deadbolt knob 18 in the secured position. This design could also prevent the latch 10 from unintentionally engaging with the deadbolt knob 18.

The latch plate 12 can, in some embodiments, approximate the thickness of a deadbolt knob back plate 20. This design can allow the latch 10 to simply extend from the latch plate 12 and surround the deadbolt knob 18 while resting against the deadbolt knob back plate 20. In some embodiments, the latch 10 can have side members that are curved to maximize the contact with the deadbolt knob 18, as shown in the Figures. Of course, the latch 10 can be made in various sizes and shapes depending on the specific application, size of the deadbolt knob 18, and the like.

While the Figures show the latch 10 fitting over the deadbolt knob 18 when the deadbolt knob 18 is in a locked position (substantially vertically), in some embodiments, a deadbolt knob 18 may be in a locked position when the deadbolt knob 18 is in a horizontal position. In this embodiment, the deadbolt latch lock of the present invention could still be used by placing the latch plate 12 on the aide of the deadbolt knob plate 20.

It should be understood, of course, that the foregoing relates to exemplary embodiments of the invention and that modifications may be made without departing from the spirit and scope of the invention as set forth in the following claims.

What is claimed is:

1. A deadbolt latch lock comprising:
a latch plate operable to attach to a door;
a latch extending from the latch plate, the latch movable between a secured position and a storage position, the secured position resulting in the latch extending on each side of a deadbolt knob when the deadbolt knob is in a locked position, preventing the deadbolt knob from turning to an unlocked position, and the storage position resulting in the latch not interfering with the turning of the deadbolt knob.

2. The deadbolt latch lock of claim 1, wherein the latch plate is attached to the door with screws that pass through screw holes formed in the latch plate.

3. The deadbolt latch lock of claim 1, wherein the latch is formed in a U-shape where the deadbolt knob is disposed inside arms of the U-shape in the secured position.

4. The deadbolt latch lock of claim 3, wherein the arms of the U-shape include a curve providing a greater contact surface area between the latch and the deadbolt knob.

5. A method for securing a deadbolt knob of a deadbolt lock in a locked position, the method comprising:
pivoting a latch from a storage position, where the latch does not interfere with movement of the deadbolt knob, to a secured position, where the latch is disposed along each side of the deadbolt knob, preventing rotation of the deadbolt knob from a locked position to an unlocked position.

6. The method of claim 5, further comprising securing a latch plate to a door with screws that pass through screw holes formed in the latch plate, the latch extending from the latch plate.

7. The method of claim 5, wherein the latch is formed in a U-shape where the deadbolt knob is disposed inside arms of the U-shape in the secured position.

8. The method of claim 7, wherein the arms of the U-shape include a curve providing a greater contact surface area between the latch and the deadbolt knob.
